(19) United States
(12) Patent Application Publication
(10) Pub. No.: US 2019/0004675 A1
(43) Pub. Date: Jan. 3, 2019

(54) FLEXIBLE LAYOUT FOR CALENDARS

(71) Applicant: Microsoft Technology Licensing, LLC, Redmond, WA (US)

(72) Inventors: Nathan Bradley Duke, Redmond, WA (US); Zachary Justin Miller, Bellevue, WA (US); Steven G. Frank, Redmond, WA (US); Robert Steven Meyer, Seattle, WA (US); Matthew Nicholas McKnett, Bellevue, WA (US)

(21) Appl. No.: 15/638,046

(22) Filed: Jun. 29, 2017

(51) Int. Cl. G06F 3/0485; G06F 9/44; G06Q 10/10

(52) U.S. Cl. CPC G06F 3/0485; G06Q 10/109; G06F 9/4443

(57) ABSTRACT

A flexible layout system is disclosed herein that improves infinite scrolling capabilities and other animations in software calendars. In an implementation, a time period of a viewport in a user interface may change relative to a panel in a calendar. As the viewport changes, a mapping component informs other components of a new time period coming into view in the view port as a result of a scrolling event. The mapping component may also respond to requests from another component with layout information for the visual representation of the new time period (e.g. position and dimension). In this manner, the responsibility for determining layout information is encapsulated.

### TECHNICAL BACKGROUND

Infinite scrolling in calendar software allows for the seemingly endless ability to navigate forward or backward in a calendar. In reality, various software components cooperate to provide the effect in a user interface to a given application. For example, various offsets must be continuously calculated and tracked as a user navigates a calendar surface in order to bring into or remove from a view port a given range of dates.

Adding to the complexity, the position and dimensions of the controls that make up a panel in a calendar must be determined on the fly as date ranges are brought into and ushered out of the view port. In a brief illustration, a user may navigate to a point in a calendar panel that is offset a certain distance from a reference point in the panel. The landing date is determined based on the offset value and a known dimension (e.g. width) of a unit of time in the calendar. A visual representation of a date range is then produced and is placed in the panel at a position also determined based on the offset. For example, a visual representation of a new week may be placed at particular coordinates in the panel.

Unfortunately, such orchestration requires a great deal of skill and effort on the part of the developers who code the underlying software components. In addition, such an arrangement may be error prone when other, more complex dynamics are occurring in the user interface. For instance, a user may switch modes or device orientation while scrolling through a calendar, resulting in disjointed displays of erroneous date ranges. This may occur because the known dimension of a unit of time has changed by the time the scrolling has stopped relative to when it began.

### OVERVIEW

Technology is disclosed herein that improves infinite scrolling capabilities and other animations in software calendars. In an implementation, a time period of a viewport in a user interface may change relative to a panel in a calendar. As the viewport changes, a mapping component informs other components of a new time period coming into view in the view port as a result of a scrolling event. The mapping component may also respond to requests from another component with layout information for the visual representation of the new time period (e.g. position and dimension). In this manner, the responsibility for determining layout information is encapsulated.

In some implementations, the mapping component may maintain an anchor date and time that is representative of a date and time of a reference position in the view port. Some or all of the layout information may be derived from the anchor. The layout anchor may be continuously updated as a user navigates backward and forward in a calendar, which may simplify coding by reducing the dependence on offsets.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a flexible layout system and a related operational scenario in an implementation.

FIG. 2 illustrates a layout process in an implementation.

FIG. 3 illustrates a layout process in an implementation.

FIG. 4 illustrates the flexible layout system from FIG. 1 and a related operational scenario in an implementation.

FIGS. 5-8 illustrate a calendar panel and related operational scenario in an implementation.

FIG. 9 illustrates a computing system suitable for implementing the calendar layout technology disclosed herein, including any of the environments, processes, and operational scenarios illustrated in the Figures and discussed below in the Technical Disclosure.

### TECHNICAL DISCLOSURE

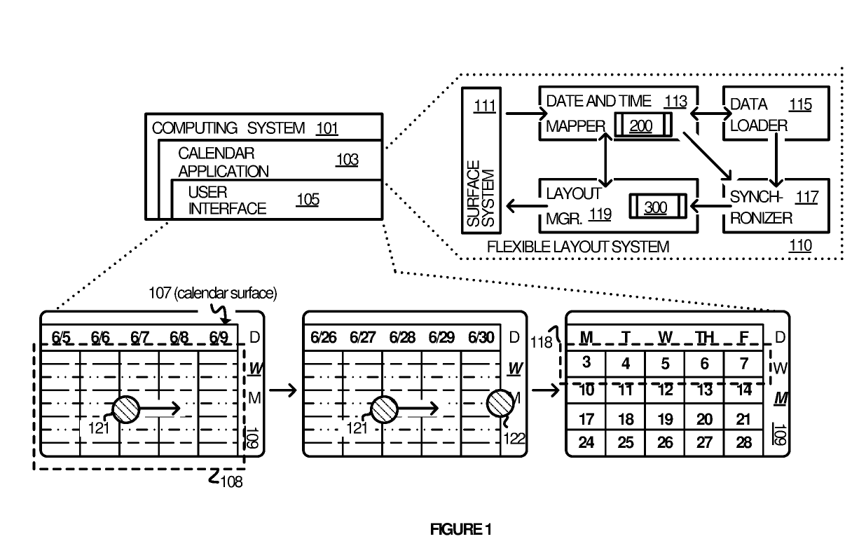

Technology is disclosed herein for implementing a flexible layout system in the context of animating a calendar in a user interface to an application. FIG. 1 illustrates a computing system 101 on which a calendar application 103 may be implemented. Calendar application 103 includes a flexible layout system 110 that assists with driving a user interface 105 to the calendar application 103. A calendar surface 107 may be rendered in the user interface 105 and animated at least in part by the components in flexible layout system 110.

Flexible layout system 110 includes a surface system 111 (which may be considered separate from the layout system in some implementations). Surface system 111 communicates with a date and time mapper, herein referred to has mapper 113. Mapper 113 communicates with data loader 115, synchronizer 117, and layout manager 119. Layout manager 119 communicates with mapper 113, synchronizer 117, and surface system 111. Synchronizer 117 and data loader 115 also communicate.

Calendar application 113 is representative of one or more software applications capable of providing a software-based calendar in a user interface. Calendar application 113 may be a stand-alone application or may be integrated with one or more other applications or modules in the context of a larger applications, such as a personal information management (PIM) application. Calendar application 103 may be a natively installed and executed application, a web application that executes in the context of a web browser, a mobile application, a desktop application, a streamed or streaming application, or any variation or combination thereof. Calendar application 113 may be implemented on one or more physical or virtual computers of which computing system 901 in FIG. 9 is broadly representative.

In a brief operational example, calendar surface 107 is initially rendered in a week mode, as evidenced by the selection of the week button in feature menu 109. Behind the scenes, a panel is maintained by flexible layout system 110, in which visual representations of time periods are built so as to be visible in the viewport. In this example, a visual representation of the date range of June 5^{th} through June 9^{th} is visible initially in the view port and is presented in a week panel 108 within the larger, unseen panel.

It is assumed for exemplary purposes that a user provides a user input 121 to calendar surface 107. The user input may correspond to a navigation event, such as scrolling backward or forward in time. The user input 121 navigates the user to a different point in the panel, which causes the flexible layout system 110 to transition the first date range out of the view port and introduce the new date range into the view port (June 26^{th}-June 30^{th}).

It is further assumed for exemplary purposes that the user input 121 continues. As the scrolling advances into the future, a second user input 122 is supplied that changes the view mode from weekly to monthly. This occurs by, for example, the user selecting the monthly view button in feature menu 109. The end result is that a new set of weeks are display in calendar surface 107.

The combination of the scrolling and the change in view mode causes flexible layout system to change what is see in the viewport. Namely, the view mode changes from weekly to monthly, meaning that multiple weeks need to be show in the viewport. This is accomplished by building multiple week panels and placing each one individually such that in the aggregate, a monthly perspective is provided.

Week panel 118 is representative of one of the week panels that may be built and rendered during the transition from weekly to monthly view. It may be appreciated that week panel 118, which is a visual representation of a date range, has different dimensions than week panel 108. This is because a single week in month view occupies less space in calendar surface 107 than a single week in week view. This may happen even when a view mode stays the same when, for example, the size of calendar surface 107 changes while a user is scrolling. Here, the user landed on the week of July 3^{th}-July 7^{th}.

The proper positioning and dimensioning of week panel 118 is accomplished by flexible layout system 110. In particular, flexible layout system 110 encapsulates date-to-position mapping in mapper 113. Date-to-position mapping is necessary for resolving the landing date for a navigation event, e.g. scrolling. Encapsulating the mapping in mapper 113 allows other components of flexible layout system 110 to be coded without concern for determining the position and dimension of an hour, day, week, or month panel, or any other visual representation of a time period.

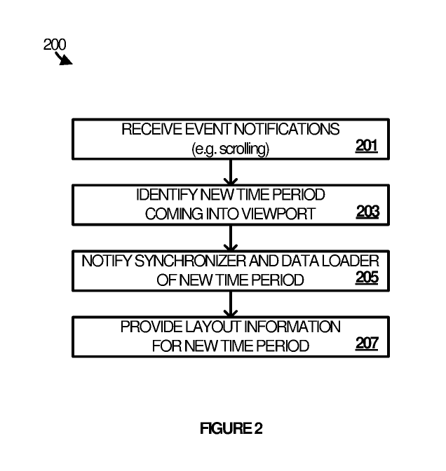

The components of flexible layout system 110 are each implemented in program instructions that may be executed on a suitable computing system, e.g. computing system 901. FIG. 2 illustrates a layout process 200 (also shown in FIG. 1) that may be implemented by mapper 113 in particular, to assist with the flexible layout of panels in calendar surface 107. Layout process 200 may be implemented in the program instructions that comprise mapper 113. The program instructions direct a processing system in a suitable computing system to operate as follows.

To begin, mapper 113 receives notifications of events from surface system 111 (step 201). As an example, mapper 113 may receive information from surface system 111 indicative of a user scrolling in user interface 103. The scroll may be accomplished via a touch gesture, mouse input, voice command, or any other suitable user input mechanism.

Mapper 113 next identifies a new time period that may be coming into a viewport as a result of the event (step 203). The new time period may be identified by accessing a table that maps positions in a panel to dates and times. In a separate operation, the table may be continuously updated in the background as aspects of the panel may change, such as its view mode, orientation, size, and the like. In another example, the new time period may be determined by a function that is executed by mapper 113. The view mode, orientation, size, or other aspects of the panel may be the inputs with which mapper 113 calculates the appropriate date and time to associate with a given date.

Having identified a new time period, mapper 113 then notifies data loader 115 and synchronizer 117 that the new time period is coming into view in the viewport (step 205). Layout manager 119 becomes aware of the new time period and queries mapper 113 for layout information related to the new time period. Mapper 113 receives the requests responds with the layout information (step 207). Examples of the layout information include, but are not limited to, the position and dimension(s) for the visual representation of the new time period.

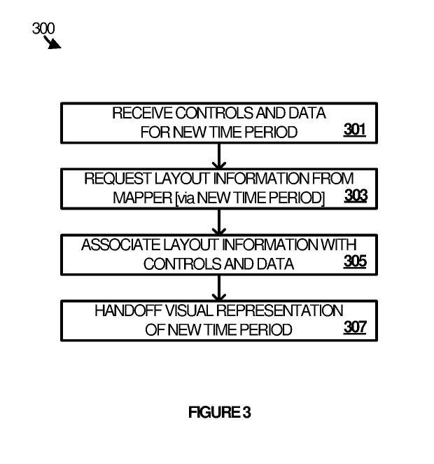

FIG. 3 illustrates a layout process 300 (also shown in FIG. 1) that may be implemented by layout manager 119 in particular, to assist with the flexible layout of panels in calendar surface 107. Layout process 300 may be implemented in the program instructions that comprise layout manager 119. The program instructions direct a processing system in a suitable computing system to operate as follows.

To begin, layout manager 119 receives controls and data for the new time period identified by mapper 113 (step 301). The controls and data are those synchronized by synchronizer 117. Layout manager 119 responsively queries mapper 113 with the new time period so as to obtain layout information for the controls and data (step 303).

Mapper 113 responds with the layout information, allowing mapper 113 to associate the layout information with a given control (step 305), thereby producing a visual representation of the new time period. Layout manager 119 may handoff the visual representation of the new time period to surface system 111, to be displayed in calendar surface 107 (step 307).

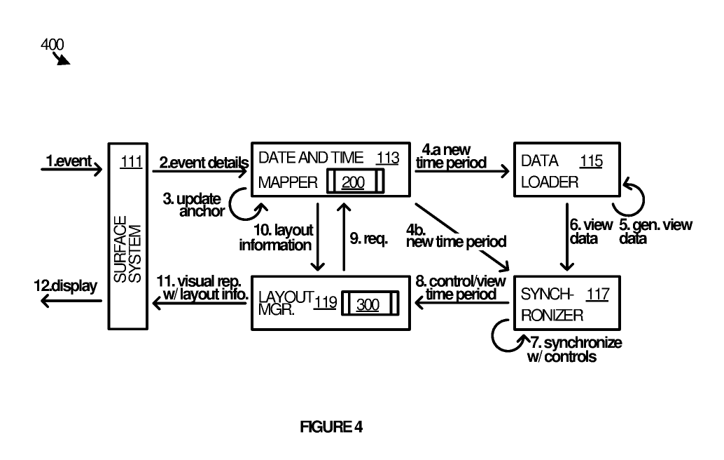

FIG. 4 illustrates a specific operational scenario 400 to better understand the relationships between the components of flexible layout system 110. In operation, an event occurs in surface system 111, such as a user navigating to a new date range by way of a touch gesture, scrolling, or the like. It may be appreciated that surface system 111 represents an abstraction layer to the remainder of flexible layout system 110. All or portions of surface system 111 may be external to flexible layout system 110 in some implementation. In addition, surface system 111 may itself be comprised of multiple software components, such as a scroll view manager, a scroll viewer, and the like.

Details of the event are provided by surface system 111 to mapper 113. The details may include, for example, a new position in the panel to which the user navigated. The position may be expressed in coordinates or any other suitable position type.

Assuming that the user has navigated to a new position in the panel, mapper 113 takes in the event details determines which specific date the user landed on. This new date and time is used to anchor the viewport. A previous value for the anchor is replaced with the new anchor and a new date range (or any other time period) is derived from the new anchor. Mapper 113 provides the new time period to data loader 115 and synchronizer 117.

Data loader 115 generates new view data in relation to the new time period provided by mapper 113. The new view data may be referred to as view models in some implementations. The data represents the individual unit(s) of time (e.g. a day, week, etc.) that will need to be expressed in the visual representation of the new time period.

Synchronizer 117 identifies which control(s) to include in the visual representation. This is done in conjunction with the view data generated by data loader 115. For instance, if data loader 115 identifies a week to be expressed in a week panel, then synchronizer 117 identifies the corresponding week control. The week control includes the image or images for the week and/or other such graphical elements.

It may be appreciated that flexible layout system 110 operates continuously as a user navigates smoothly in an infinite layout scenario. Thus, new time periods are constantly being identified, created, and destroyed, as a user navigates backward and forward in time. Thus, it may be understood that data loader 115 produces multiple data views and synchronizer 117 identified multiple controls to associate with the views. For the sake of simplicity, a given combination of a data view and a control is provided to layout manager 119, along with the specified date range.

For a given package produced by synchronizer 117, layout manager 119 queries mapper 113 for the position and dimension(s) of the visual representation of the date range. Mapper 113 responds with the layout information, allowing layout manager 119 to handoff the visual representation to surface system 111. Surface system 111 may then render the visual representation of the new time period at its specified position in the underlying panel and in accordance with its specified dimensions (e.g. height and width).

FIGS. 5-8 illustrate another operational scenario. In operation, a panel 501 is maintained by a flexible layout system on which new time periods are added (and sometimes removed). Panel 501 in this example scenario includes various date ranges, represented by date range 502, date range 503, and date range 504. A viewport 505 defines which date range is presently displayed on a calendar surface.

Panel 501 is initially oriented in a weekly mode. As such, the individual sections of panel 501 represent specific days. The flexible layout system maintains an anchor date and time (anchor 506) for the furthest left day in the viewport 505. A future date 507 is represented by different shading than the anchor 506.

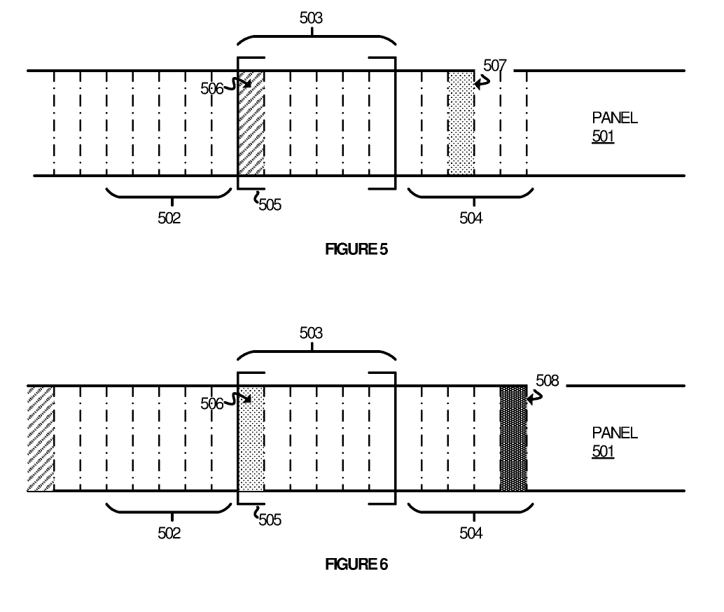

It is assumed for exemplary purposes that a navigation event occurs whereby the user scrolls to the future date 507. This moves the future date into the view port 505 in FIG. 6, at which point it becomes the anchor 506 and the anchor is updated with its date and time values. A new future date 508 is shown to illustrate how the date ranges have shifted to the left as a result of the scrolling navigation. Note that the anchor 506 remains in the viewport, although its associated date and time value changes as position of the viewport 506 with respect to panel 501 changes.

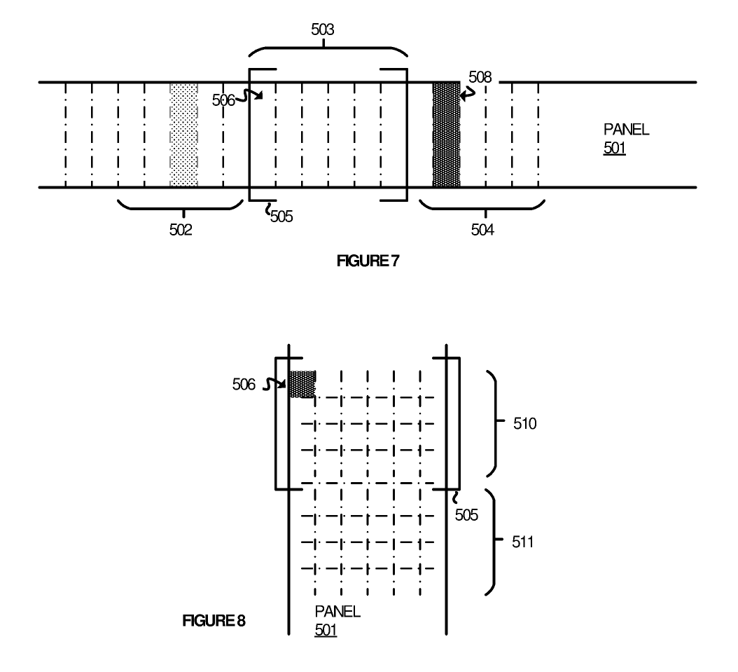

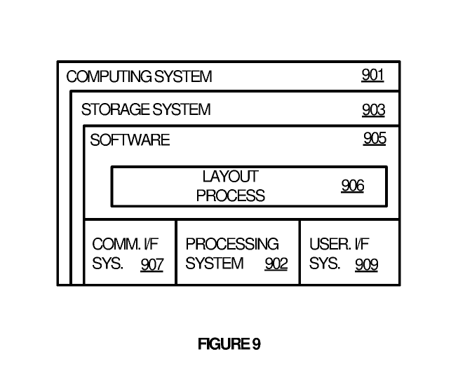

In FIG. 7, the user has continued the scroll, moving the old anchor date out of the viewport and brining the future date 508 closer to the view port. Between FIG. 7 and FIG. 8, the user changes the view mode from week to month, thereby causing the orientation of panel 501 to change from a horizontal frame of reference to a vertical frame of reference. Panel 501 now contains various weeks arranged vertically, with each week containing various days. New date ranges are present in date range 510 and date range 511.

It may be assumed for exemplary purposes that the future date range 508 became the landing date as a result of the scroll. As such, the anchor 506 is updated with its date and time value. When the view mode transitions from the weekly view mode to the monthly view mode, the flexible layout system knows to anchor the visualization of the date range at the date and time value of the anchor.

The following discussion relates to an implementation of a flexible layout system. The user interface to a calendar application may include a calendar surface and immersive items (or item details), where users can create and edit calendar items (meetings, events, appointments). The calendar surface (or surface) is where users have multiple ways to experience their calendar items in time. For example, a surface may include a daily, weekly or monthly view mode on a calendar page.

Each view mode represents a different way of presenting calendar information visually. Month view mode displays five weeks at a time, each week displaying seven days. This leaves only enough room to display a handful of appointments on each day. Month view's smallest granularity of time is the day. On the other end of the spectrum is the day view, where only a single day is displayed at a time, so there is enough room to show all of its appointments. Indeed, all 24 hours of the day are displayed, and appointments are arranged in proportion to when they occur within the day. Day view's smallest granularity is the minute.

Flexible layouts provide a way to reuse the controls that implement the views discussed above. Generally speaking, a layout is a class or set of classes containing logic for positioning controls within a Cartesian coordinate space. The layout prescribes the size and position of every control in its purview. Example layouts include Panels to contain controls. Every Panel utilizes an implementation of an ILayout interface to act as the layout for the controls it hosts. When a user switches views in the Calendar app, what is happening is the switching of the layout of Week, Day, and Appointment controls within a Panel (and occasionally generating a few new controls unique to that view).

Flexible layouts provide for an improved implementation of infinite scrolling in a Calendar Surface. In this implementation, the Calendar Surface exists in a ScrollViewer. Time is represented like an enormous picture over which to hover and zoom in and out on to see more or less detail. However, such infinite capabilities are an effect provided by a finite number of controls. That number may be relatively small in some implementations, especially in the context of using XAML controls, as XAML controls are costly in terms of memory.

The effect is accomplished by shuffling controls around as the user scrolls. During a scroll, when a control goes off screen, the layout changes the position of that control such that it is next in line to come on screen, swapping out its view model in the process so that it updates visually to display the new region of time.

Just as an infinite number of controls isn't possible, neither is positioning controls in an infinitely large Panel, which is prohibited by XAML. When the user scrolls, what she is really doing is moving the viewport of a ScrollViewer over a stationary Panel. Through the shuffling, the flexible layout system ensures that controls are always positioned in the Panel directly underneath the viewport. However, since the Panel must be finite in size, if the user scrolls far enough, the viewport will hit the edge of the Panel where it cannot scroll any farther.

To solve this problem, flexible layouts have to be able to “re-center” the viewport. When the viewport gets close to the edge of the Panel, the system tells the ScrollViewer to move back to the center of the panel, and, simultaneously, the layout is told to move the controls there too. This all happens quickly enough that the user cannot tell that anything has changed. To prevent having to re-center often, the Panel may be quite large: usually 1 million pixels in one dimension.

The Calendar Surface isn't a static perspective of time: on a whim, the user can change the entire layout by going from any view mode to any other view mode. To make these transitions as seamless as possible, the flexible layout system reuses already-in-memory controls across transitions when possible. Moreover, a view mode transition can be triggered in the middle of another user action, like scrolling or resizing the app window. In short, there are a lot of moving parts in the app, and view mode transitions involve coordinating the actions of the Scroll Viewer, multiple Panels, their layouts, and individual controls. The flexible layout system orchestrates this undertaking within the app.

The flexible layout system provides a mapping from date-times to the Cartesian coordinate space. This mapping is valuable for a variety of features in the app. Just about anything that deals with the locations or sizes of time-based controls needs to know the mapping. Unfortunately, the mapping is difficult to calculate in most views, and even small mistakes can be visually disastrous. As a result, the calculation as contemplated herein is done in one shared location. This centralization of layout knowledge is balanced against the need to keep the code modular and well-factored for extension without modification. Managing the complexity of the layout system with its various moving parts and need for broad accessibility is a very real engineering challenge.

Infinite layouts are the gatekeepers of the date-to-position mapping within the system. They expose methods such as GetDateFromPosition, GetPositionFromDate, GetBoundingRectFromDateRange, etc. Every Panel that lays out time-based controls (Weeks, Days, Appointments) needs an infinite layout. Panels can share the same infinite layout instance as long as they have exactly the same layout requirements. Similarly, any component that needs to convert between date-times and Panel positions will need to consume an infinite layout.

In order to convert between the date-time coordinate system and the Cartesian coordinate system, infinite layouts store a pair of points, one from each system, that map to each other. This pair is called a layout anchor. Hence, layout anchors contain a date-time and an ordered pair of Cartesian coordinates. Layout calculations are done relative to this anchor. For example, if the anchor is {3/14/2017 12:25:16.00, (100, 36)} and a client requests the date of the position (200, 36), the infinite layout's sub-layout can use the difference between the given point and the anchor point to compute the difference between the anchor date and the requested date, yielding the requested date.

Importantly, there are an infinite number of choices for the layout anchor—any date can map to any position. This is what makes re-centering possible. A recentering operation re-associates the next visible date (initially located past the edge of the Panel) with a position at the center of the Panel, safely far away from the edges. This also grants the system with a great deal of flexibility in how it locates controls within the Panel. For example, it is possible for the user to request a scroll to a faraway date, but, because scrolls take time, long-distance scrolling could be annoying. The layout anchor provides a simple solution: just re-associate the desired date with the current viewport position. This operation may be referred to as a “teleport”, since the viewport instantly shows a new range of time without having moved at all. The layout anchor may be the top-left point of the viewport and the date-time that most closely aligns with that point. Therefore, the anchor must be constantly updated during a scroll.

The Calendar app's views are fundamentally oriented. Time always flows from left to right (the horizontal orientation) or from top to bottom (the vertical orientation). Infinite scrolling occurs in the axis along which time flows. For example, in Week view mode and other horizontal view mode, infinite scrolling is only possible to the left and right, not up and down. Since re-centering needs to happen only in one dimension, Panels are always much longer in that dimension than in the other. The longer axis is called the major axis; the shorter axis is the minor axis. Much of the layout logic can be made indifferent to the view's orientation if it is phrased in terms of major/minor coordinates instead of x/y coordinates. This saves coders from having to write the logic twice, one version where the x-axis is the major axis and another where the y axis is. The layout anchor reflects this orientation, too. Rather than containing a datetime and a standard Cartesian point, it contains a date-time and an oriented point: a tuple consisting of a major axis coordinate, a minor axis coordinate, and a flag indicating whether the point is in the horizontal or vertical orientation. For illustrations, oriented points will be written as (major coordinate, minor coordinate).

Every infinite layout has-a component called the sub-layout. The sub-layout encapsulates view-specific layout information and logic. There is a different sub-layout implementation for every view mode in the app. By contrast, infinite layouts are entirely view-mode agnostic; the same instance can be reused in any view mode. Sub-layouts expose the same date-to-position mapping methods as infinite layouts, but their signatures differ: sub-layouts do not store their own anchors, so all of their methods take in an anchor in order to calculate the result. The division of labor is essentially this: sub-layouts contain view-specific logic but no mutable state, while infinite layouts contain mutable state but no view-specific logic.

There are several parameters that affect the layout, including the current view, the size of the viewport, the first day of the week, the number of weeks that should be displayed at a time, etc. Treating each of these parameters as a mutable property on one or more of the layout components leads to fragility—too many ways to order property changes, too many intermediate states that the object(s) can be in. Instead, the flexible layout system makes the parameters immutable and encapsulate them in a single class. When one of the parameters changes, the entire instance of that class is thrown away and a new instance is generated. Another benefit of extracting the sub-layout into its own class is that the many consumers of infinite layouts don't each individually have to replace their instances whenever a parameter changes. Instead, there can be one central location that is sensitive to layout parameter changes and whose responsibility is to hot-swap the sub-layouts so that consumers of infinite layout can remain unaware that anything changed.

Up to now, we have treated all infinite layouts as one concept. In reality, there are two classes of infinite layouts: primary and secondary. What they have in common is access to the date-to-position mapping provided by a sub-layout. They diverge in their additional responsibilities and in the ways in which they are used in the system.

For each ScrollViewer that will be used to implement a view mode with infinite scrolling, there may be exactly one primary layout. The primary layout is the sole keeper of the layout anchor. It interacts with another component, the ScrollViewerManager, to keep the anchor up-to-date. It also exposes methods for doing re-centering and teleporting. Additionally, the primary layout is solely responsible for calculating snap points and for knowing how to do paging. There can be only one primary layout (per ScrollViewer) because its responsibilities are not duplicated. The ScrollViewer, for instance, accepts only one source of snap points (through an object implementing the IScrollSnapPointsInfo interface); having more than one component capable of calculating them would be wasteful. A more salient example: storing copies of the layout anchor in multiple components would require them all to perfectly synchronize updates to the anchor, an error-prone situation.

In most views, more than one Panel of controls is needed to complete the view. Secondary layouts provide layout calculations for these additional Panels. For example, in Month view mode when week numbers are enabled, there is a Panel of Weeks and a Panel of WeekNumberLabel controls. The Panel of Weeks uses the primary layout; the other uses the secondary layout. There can be any number of secondary layouts per ScrollViewer. Secondarylayouts still need the layout anchor for doing layout calculations, so they all rely on the primary layout for it. Secondary layouts do not rely on the primary layout for their sub-layouts, however. This is because, typically, the layout of controls in the other Panels is subtly different from the primary layout. With that said, there is almost always a close correlation between them, so much so that the secondary layout may destroy its sub-layout when the primary layout announces that its sub-layout has changed. This way, a failure to update all of the sub-layouts together results in a crash as soon as an operation is requested that requires the sub-layout.

Sub-layouts may also be grouped into primary and secondary classes. The difference is far less significant, however, as primary sub-layouts merely add a few more methods to the interface used by secondary sub-layouts. Thus, a primary sub-layout can be used by a secondary layout. (A secondary sub-layout cannot be used by a primary layout, though.)

On top of primary and secondary layouts, additional layout information may be composed to make layouts data-aware. Layout information may be provided from the layout system that provides positions and dimensions based on time and duration, which may be further subdivided to disambiguate, for example, overlapping calendar controls. The base layout provided to a Panel, TimeBasedControlLayout consumes an infinite layout (either primary orsecondary). In its Measure and Arrange methods, the class uses infinite layout's GetBoundingRectFromDateRange method to translate the time range of each control in the Panel to its position and size. No additional layout properties can be set on TimeBasedControlLayout; it is simply a middleman between infinite layout and the Panel.

Generally speaking, TimeBasedControlLayout should be used when the position and size of each control in the Panel is solely dependent on the time range the control represents. Put differently, the position and size of each control must be totally independent of those of the other controls in the Panel. When that condition does not hold, a different layout component is necessary.

FixedHeight- and FixedWidthTimeBasedControlLayout FixedHeightTimeBasedControlLayout works very much like TimeBasedControlLayout—using an infinite layout to measure and arrange children—but adds two new capabilities. The first, the UseFixedHeight method, allows consumers to specify the height of the Panel and all of its children rather than deferring to infinite layout for that information. The second, UseAutoHeight, causes the layout to measure all children with infinite available height and then uses the maximum desired height for the height of all children and the Panel.

FixedWidthTimeBasedControlLayout works exactly the same way but overrides the width instead of the height.

The InfiniteAllDayAppointmentsLayout is specifically for the Panel of all-day Appointment controls in the SurfaceTopHeader in Week and WorkWeek views. The width and x-coordinate of an Appointment in the Panel directly correlates with that Appointment's time range (an infinite layout is used to do the conversion). However, the time ranges of the appointments in this Panel often overlap, and, when they do, it is not acceptable to overlay the controls on top of each other. Instead, the desired behavior is for the Appointments to stack vertically. Since the Appointments can have varying durations, they can also have varying widths. This makes deciding how best to stack them difficult. As a result, the system uses an algorithm (encapsulated in the ConflictCalculator) that takes as input the time ranges of the entire set of Appointments in the Panel and outputs a y-coordinate and height for each Appointment. In sum, the layout of all-day Appointments is not solely dependent on their time ranges; it depends on the sizes and shapes of other all-day Appointments in the Panel. InfiniteAllDayAppointmentsLayout implements this layout.

ConflictAwareTimeBasedControlLayout is a generalization of InfiniteAllDayAppointmentsLayout for any kind of time-based control, though it uses a different conflict resolution algorithm (specifically, horizontal placement of overlapping single-day ranges). This layout is a good candidate for further generalization in order to accommodate any sort of conflict resolution algorithm.

For each Scroll Viewer that will be used to implement a view mode with infinite scrolling, there must be exactly one ScrollViewerManager. The ScrollViewerManager has two responsibilities. First, it wraps the ScrollViewer in an interface more friendly to the types of operations one often has to perform in the Calendar app. The ScrollViewer's interface exposes only one method for programmatically changing the viewport—it's called ChangeView—and that method takes in plain x- and y coordinates. Given the oriented nature of Calendar's views, an alternative method would take in an oriented point instead, that way programmatic scrolling logic can be agnostic to the particulars of the layout. Another alternative would be a method that takes in a target date to display and translates it to a desired viewport location a ScrollToDate function. Other, more complicated operations could be possible, too, such as the ability to force a teleport to a date or to bring an entire bounding rectangle into the viewport (rather than scrolling to a single point). Such capabilities are exposed by the ScrollViewerManager. Additionally, the ScrollViewerManager tracks useful state during a scroll, such as IsInProgrammaticScroll, and fires events when those states change.

The second responsibility of the ScrollViewerManager is updating the primary layout's anchor in response to viewport movements. Recall that the anchor is chosen to be the top-left corner of the viewport (date-time and position). This means that, when the viewport moves, the anchor must update as well. It's necessary for the correctness of the layout that the anchor be as close to the viewport as possible at all times, meaning that updates occur throughout the duration of a scroll, not just at the end. Fortunately, the Scroll Viewer fires ViewChanged events fairly rapidly during a scroll. In the typical case, ScrollViewerManager handles these events by calling UpdateAnchorForScroll on the primary layout. In the event that the viewport is nearing the edge of the Panel, the ScrollViewerManager detects this and recenters, moving the viewport to the center of the Panel and prompting the primary layout to re-map its anchor date to the centered location.

The layout infrastructure disclosed herein does not depend on view models. The only requirement that the layout imposes on controls is that they implement ITimeBasedControl so that their respective time ranges can be ascertained; that interface doesn't presume the existence of a view model. Nevertheless, view models are a pervasive and important, as they play a crucial role in accomplishing the infinite scrolling illusion.

Every custom control in the app is given a view model containing business logic and data that tell the control how to present itself visually. For example, AppointmentViewModel provides the subject, start and end times, location, and other details that the Appointment control displays. Likewise, the WeekViewModel gives the Week control a time range of exactly one week, which it uses to create Day controls, one for each day. The key to the infinite scrolling illusion is reusing the same control over and over in different places during a scroll, and this is made possible by the fact that a control's view model can be swapped out, causing it to visually refresh.

The set of view models for a given control are arranged in a tree structure that mirrors the UI tree (the tree of realized XAML controls). For example, the control that houses all of the views on the CalendarPage is called the CalendarSurface; it has a CalendarViewModel. The CalendarSurfacecontains Week controls; likewise, the CalendarViewModel contains WeekViewModels, one for each Week on screen (and a few for off-screen weeks, for the purposes of buffering). The Week control contains Days; the WeekViewModel contains DayViewModels. Finally, Days contain Appointments; DayViewModel contains AppointmentViewModels. The entire experience can be refreshed to represent a completely new range of time simply by replacing the WeekViewModels in the CalendarViewModel, and that is exactly what happens during a scroll. When the viewport moves from, for example, the week of Jan. 8, 2017 to the week of Jan. 15, 2017, the view model for one of the Weeks that has gone off-screen is replaced by a WeekViewModel representing the week of Jan. 15, 2017.

Merely shuffling around the view model tree would have no effect on the UI tree if it weren't for a component called theSynchronizer. As its name implies, the Synchronizer's job is to keep the two trees in sync. To do this, a Synchronizer is given a Panel of controls and an IObservableVector of view models that go with those controls. Synchronizers are templated, so any view model-control pair will work, but a focus is on Weeks and WeekViewModels. When the vector of WeekViewModels changes due to an insertion, it fires an event describing where the insertion took place. The Synchronizer handles this event by asking the Panel to realize a Week control at the corresponding index. It then assigns the inserted view model to the realized Week. When the vector changes due to a deletion, the Synchronizer asks the Panel for the Week at the corresponding index to be removed. During a scroll, the CalendarViewModel receives notifications of the visible date range changing from the CalendarSurface. It responds by updating its vector of WeekViewModels in order to fill the entire visible date range (and then some—again, because of buffering). A Synchronizer detects changes to that vector of WeekViewModels and responds by removing and realizingWeek controls in the Panel until the set of Weeks matches the set of WeekViewModels. TimeBasedControlLayout responds to changes in the Panel's contents by repositioning the controls which, due to their newly assigned view models, causes them to shuffle around to just the right positions, creating the infinite scrolling illusion.

The process is even more interesting when you understand what is really meant by realizing and removing controls in a Panel. Because XAML controls are so costly in terms of memory, it is noticeably time consuming to destroy and allocate controls often. Therefore, Panels are designed to recycle controls when possible. When a control is removed from a Panel, the Panel removes the item from the UI tree but saves it in a private collection akin to a recycle bin. Later, when a client asks the Panel to realize a control, it will pull one out of the recycle bin if it can. So, no matter how far the user scrolls in the app, a constant number of Weeks is ever created. Infinite scrolling works very much like laying a temporary railroad: as the train (the viewport) moves past a plank (a Week), that plank is moved (by the layout) from behind the train all the way to the front of the train and is the next plank the train rolls over. The process repeats indefinitely until the train comes to a stop.

FIG. 9 illustrates computing system 901, which is representative of any system or collection of systems in which the various applications, services, scenarios, and processes disclosed herein may be implemented. Examples of computing system 901 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909 (optional).

Processing system 902 loads and executes software 905 from storage system 903. Software 905 includes layout process 906, which is representative of the processes discussed with respect to the preceding FIGS. 1-8, including layout process 200 and layout process 300. When executed by processing system 902 to enhance calendar layouts, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device, but may also be distributed across multiple processing devices or sub-systems that cooperate in executing program instructions. Examples of processing system 902 include general purpose central processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device, but may also be implemented across multiple storage devices or sub-systems co-located or distributed relative to each other. Storage system 903 may comprise additional elements, such as a controller, capable of communicating with processing system 902 or possibly other systems.

Software 905 may be implemented in program instructions and among other functions may, when executed by processing system 902, direct processing system 902 to operate as described with respect to the various operational scenarios, sequences, and processes illustrated herein. For example, software 905 may include program instructions for implementing layout process 200 and layout process 300.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtual machine software, or other application software, in addition to or that include layout process 906. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system enhance calendar layouts. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 909 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 909. In some cases, the input and output devices may be combined in a single device, such as a display capable of displaying images and receiving touch gestures. The aforementioned user input and output devices are well known in the art and need not be discussed at length here.

User interface system 909 may also include associated user interface software executable by processing system 902 in support of the various user input and output devices discussed above. Separately or in conjunction with each other and other hardware and software elements, the user interface software and user interface devices may support a graphical user interface, a natural user interface, or any other type of user interface.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled with the one or more computer readable storage media; and
program instructions stored on the one or more computer readable storage media and comprising a plurality of components of an application for animating a calendar in a user interface to the application;
wherein the plurality of components comprises a mapping component that, when executed by the processing system as a time period of a viewport of the user interface changes relative to a panel in the calendar, directs the processing system to at least:
inform other components of the plurality of components of a new time period coming into view in the view port as a result of a navigation event in the user interface;
receive requests from at least one other component of the plurality of components for layout information mapped to the new time period; and
respond to the requests with the layout information for displaying a visual representation of the new time period in the panel.

2. The computing apparatus of claim 1 wherein the one other component of the plurality of components comprises a layout component that directs the processing system to submit the requests for the layout information to the mapping component and directs the processing system to instruct a panel build component to build the visual representation of the new time period in accordance with the layout information.

3. The computing apparatus of claim 2 wherein the other components of the plurality of components comprise a data loader component that directs the processing system to produce new view data to be expressed through controls in the visual representation of the new time period.

4. The computing apparatus of claim 3 wherein the other components of the plurality of components further comprise a synchronizer component that directs the processing system to synchronize the new view data with the controls and to pass the new time period to the layout component.

5. The computing apparatus of claim 4 wherein the layout information comprises a position for each of the controls in the panel and dimensions for each of the controls.

6. The computing apparatus of claim 1 wherein the mapping component further directs the processing system to maintain an anchor date and time that represents a date and time of a reference position in the view port.

7. The computing apparatus of claim 6 wherein the mapping component further directs the processing system to derive the new time period from the anchor date and time.

8. The computing apparatus of claim 1 wherein the navigation event comprises switching view modes while scrolling through the calendar in the user interface.

9. One or more computer readable storage media having program instructions stored thereon comprising a plurality of components of an application for animating a calendar in a user interface to the application;
wherein the plurality of components comprises a mapping component that, when executed by a processing system as a time period of a viewport of the user interface changes relative to a panel in the calendar, directs the processing system to at least:
inform other components of the plurality of components of a new time period coming into view in the view port as a result of a navigation event in the user interface;
receive requests from at least one other component of the plurality of components for layout information mapped to the new time period; and
respond to the requests with the layout information for displaying a visual representation of the new time period in the panel.

10. The one or more computer readable storage media of claim 9 wherein the one other component of the plurality of components comprises a layout component that directs the processing system to submit the requests for the layout information to the mapping component and directs the processing system to instruct a panel build component to build the visual representation of the new time period in accordance with the layout information.

11. The one or more computer readable storage media of claim 10 wherein the other components of the plurality of components comprise a data loader component that directs the processing system to produce new view data to be expressed through controls in the visual representation of the new time period.

12. The one or more computer readable storage media of claim 11 wherein the other components of the plurality of components further comprise a synchronizer component that directs the processing system to synchronize the new view data with the controls and to pass the new time period to the layout component.

13. The one or more computer readable storage media of claim 12 wherein the layout information comprises a position for each of the controls in the panel and dimensions for each of the controls.

14. The one or more computer readable storage media of claim 9 wherein the mapping component further directs the processing system to maintain an anchor date and time that represents a date and time of a reference position in the view port.

15. The one or more computer readable storage media us of claim 14 wherein the mapping component further directs the processing system to derive the new time period from the anchor date and time.

16. The one or more computer readable storage media of claim 9 wherein the navigation event comprises scrolling through the calendar in the user interface.

17. A method for animating a calendar in a user interface to an application as a time period of a viewport of the user interface changes relative to a panel in the calendar, the method comprising:
in a mapping component of the application, informing at least a view component of the application and a synchronizer component of the application of a new time period coming into view in the view port as a result of a scrolling event in the user interface;
in the mapping component, receiving requests from at least a layout component of the application for layout information mapped to the new time period; and
in the mapping component, responding to the requests with the layout information for displaying a visual representation of the new time period in the panel.

18. The method of claim 17 further comprising in the layout component submitting the requests for the layout information to the mapping component and requesting a surface system to handle the visual representation of the new time period in accordance with the layout information.

19. The method of claim 18 further comprising:
in a view component, producing new view data to be expressed through controls in the visual representation of the new time period; and
in a synchronizer component, synchronizing the new view data with the controls and passing the new time period to the layout component.

20. The method of claim 19 wherein the layout information comprises a position for each of the controls in the panel and dimensions for each of the controls and wherein the method further comprising:
in the mapping component, maintaining an anchor date and time that represents a date and time of a reference position in the view port; and
in the mapping component, deriving the new time period from the anchor date and time.
